(19) United States
(12) Patent Application Publication
(10) Pub. No.: US 2003/0053140 A1
(43) Pub. Date: Mar. 20, 2003

(54) Method of controlling image reading system and control program thereof

(75) Inventor: Hiroshi Kakutani, Kahoku-gun (JP)

Correspondence Address: STAAS & HALSEY LLP, 700 11TH STREET, NW, SUITE 500, WASHINGTON, DC, 20001, US

(73) Assignee: PFU Limited, Ishikawa (JP)

(21) Appl. No.: 10/238,715

(22) Filed: Sep. 11, 2002

(30) Foreign Application Priority Data
Sep. 19, 2001 (JP) 2001-285612

(51) Int. Cl. H04N 1/40; H04N 1/23

(52) U.S. Cl. 358/302; 358/3.01

(57) ABSTRACT

An image reading method controls an image reading system including an image reading apparatus having a mechanism for scanning photographic film and a host computer receiving image data from the image reading apparatus. The method has steps of detecting each of image component of dust resulting from dust stuck to the photographic film which is read by the image reading apparatus, and removing only the image component of the dust resulting from the read dust to correct the image data.

### BACKGROUND OF THE INVENTION

1. Field of the Invention

This invention relates to a method of controlling an image reading system and a control program thereof and, more particularly, to a control method of controlling an image reading system including an image reading apparatus having a mechanism for scanning photographic film and a host computer receiving image data from the image reading apparatus, wherein a dust component resulting from dust that is stuck to the photographic film and read by the image reading apparatus at the time of reading the photographic film is removed to correct the image data, and relates to an image reading system control program for defining the process of the control method.

2. Description of the Related Art

Reading photographic film image by an image reading apparatus provides the following characteristics. First, transmitted light and high magnification are used to read photographic film images because the area of the film is small and, consequently, the image reading apparatus should be set at a high resolution. Next, it is difficult to prevent minute dust from sticking to photographic film even using great care at the time of handling the film from which an image is read. In addition, even minute dust on the photographic film may become highly visible in a highly magnified, high-resolution read image. The term “dust” as used herein refers to minute dust that cannot be prevented from sticking to photographic film even with great care.

Methods have been proposed for removing a dust image portion from image data read from photographic film to which minute dust is stuck. To remove such a dust image portion, methods have been proposed that blur a dust image portion to obscure it. However, because the entire image is subjected to the process for burring a dust image portion, the effect of the blurring is also exerted on the remaining area of the image. As a result, the entire image is blurred and degraded as the trade-off for obscuring the dust image portion.

Control performed by an image reading system to read a photographic film image according to prior art will be described below with reference to FIGS. 10 through 12.

FIG. 10 schematically shows a configuration of an image reading system according to prior art. An image reading apparatus 2 having a film scanning unit 21 is connected to a host computer 5. The image reading apparatus 2 provides image data to the host computer 5. The host computer 5 includes a dust removal unit for obscuring dust image portions in the image data received from the image reading apparatus 2.

A process performed by an image reading system for controlling image data processing according to the prior art will be described below with reference to FIGS. 11 and 12.

Referring to a block diagram shown in FIG. 11, the image reading system includes an image reading apparatus B02 and a host computer B05. The image reading apparatus B02 has a film scanning unit B21. The host computer B05 includes a dust removal unit B57 for removing an image component of a dust from the image data provided from the image reading apparatus B02 and a control program unit B59 for storing a control program that defines a process for controlling the image reading system.

Referring to a flowchart shown in FIG. 12, a control process performed by the image reading system will be described below. Reference numerals used in the description of the steps of the control process correspond to those indicated in FIG. 11.

At step S51, an operator loads the film scanning unit B21 of the image reading apparatus B02 with photographic film and activates a read operation. The film scanning unit B21 scans the photographic film of interest to generate read image data at step S52. The image reading apparatus B02 transfers the read image data to the host computer B05 at step S53. The host computer B05 receives the read image data transferred from the image reading apparatus B02 at step S54. Then, the process proceeds to step S55 and, if the operator instructs the image reading apparatus B02 to remove image components of the dust from the read image data, the process further proceeds to step S56, where the dust removal unit B57 performs a dust removal operation. The dust removal may be accomplished by using mean value filtering, for example, of pixels of interest to convert sharp projected portions in the data into data with a smooth rate of change, to thereby obscure read image components of the dust. Of course, the filtering is applied to the entire area of the picture. As a result, the image components of the dust are obscured and, disadvantageously, the sharpness of the entire image is degraded. The image data from which the image components of the dust are removed at step S57 is stored in a given file. Then, the process proceeds to step S58 and, if no further read task follows, this reading process will end.

As described above, the image component of a dust removal method in the prior-art, which uses filtering to obscure image components of the dust, has such a problem that not only the image components of the dust are obscured but the sharpness of the entire image is degraded.

### SUMMARY OF THE INVENTION

An object of the present invention is to provide an image reading system control method of removing an image component of a dust without degrading the sharpness of a photographic film image.

Another object of the present invention is to provide an image reading system control program to remove an image component of a dust without degrading the sharpness of a photographic film image.

Still another object of the present invention is to provide a computer readable medium recording an image reading system control program to remove an image component of a dust without degrading the sharpness of a photographic film image.

To solve the above-described problems, the preset invention uses the following steps. Image components of the dust contained in image data read by an image reading apparatus from photographic film is identified according to the present invention. Then, image data correction is applied to only the identified image components of the dust. These steps provide an advantage that image components of the dust are removed without degrading the image quality of the entire image data.

A method of controlling an image reading system of the present invention controls the system including an image reading apparatus having a mechanism for scanning photographic film and a host computer receiving image data from the image reading apparatus. The method comprises detecting each of image component of dust resulting from dust stuck to the photographic film which is read by the image reading apparatus, and removing only the image component of the dust resulting from the read dust to correct the image data.

This embodiment provides the advantage that only image components of the dust are removed without degrading the image quality of image data provided from the image reading apparatus.

Preferably, in the image reading system control method of the present invention, the host computer applies binarization to multi-valued image data provided from the image reading apparatus to generate a binary image, the binarization determining a threshold according to each of pixel data, and applies labeling to the binary image to enclose each of black block images with a box and specifies an image component of a black block image which has a value less than a predetermined reference value as an image component of a dust.

This embodiment provides the advantage that the host computer identifies on a pixel basis the image components of the dust in the read image provided from the image reading apparatus.

Preferably, in the image reading system control method of the present invention, the host computer applies image correction to each pixel (read pixel) which is specified as the image component of the dust to remove the image component of the dust.

This embodiment provides the advantage that the image reading system corrects only image components of the dust in the read image data.

An image reading system of the present invention comprises an image reading apparatus having a mechanism to scan photographic film, and a host computer receiving image data from the image reading apparatus. The host computer further comprises detecting means for detecting each of image component of dust resulting from dust stuck to the photographic film which is read by the image reading apparatus, and removing means for removing only the image component of the dust resulting from the read dust to correct the image data.

This embodiment provides the advantage that only image components of the dust are removed without degrading the image quality of image data provided from the image reading apparatus.

An image reading system control program controls an image reading system including an image reading apparatus having a mechanism for scanning photographic film and a host computer receiving image data from the image reading apparatus. The program causes the computer to perform detecting each of image component of dust resulting from dust stuck to the photographic film which is read by the image reading apparatus, and removing only the image component of the dust resulting from the read dust to correct the image data.

A computer readable medium records an image reading system control program to control image reading system including an image reading apparatus having a mechanism for scanning photographic film and a host computer receiving image data from the image reading apparatus. The program causes the computer to perform detecting each of image component of dust resulting from dust stuck to the photographic film which is read by the image reading apparatus, and removing only the image component of the dust resulting from the read dust to correct the image data.

These embodiments of the program and computer readable medium thereof provide the advantage that the image reading system has the control steps of identifying individual image components of the dust and applying correction only to the individual image components of the dust.

### BRIEF DESCRIPTION OF THE DRAWINGS

FIG. 1 is a diagram for illustrating a principle according to a typical embodiment of the present invention.

FIG. 2 is a diagram for illustrating image generation according to the typical embodiment of the present invention.

FIG. 3 is a diagram for illustrating image generation according to the typical embodiment of the present invention.

FIG. 4 is a diagram for illustrating image generation according to the typical embodiment of the present invention.

FIG. 5 is a diagram for illustrating image generation according to the typical embodiment of the present invention, wherein, FIG. 5A shows information representing coordinates of dust pixels, FIG. 5B shows original image data distribution, FIG. 5C shows removal of the dust pixels, and FIG. 5D shows interpolation of the removed portion shown in FIG. 5C.

FIG. 6 is a diagram illustrating image generation according to the typical embodiment of the present invention.

FIG. 7 is a block diagram of a typical embodiment of the present invention.

FIG. 8 is a flowchart of the typical embodiment of the present invention.

FIG. 9 is a flowchart of the typical embodiment of the present invention.

FIG. 10 is a diagram for illustrating a principle according to prior art.

FIG. 11 is a block diagram of an image reading system according to prior art.

FIG. 12 is a flowchart of a process according to the prior art.

### DETAILED DESCRIPTION OF THE PREFERRED EMBODIMENTS

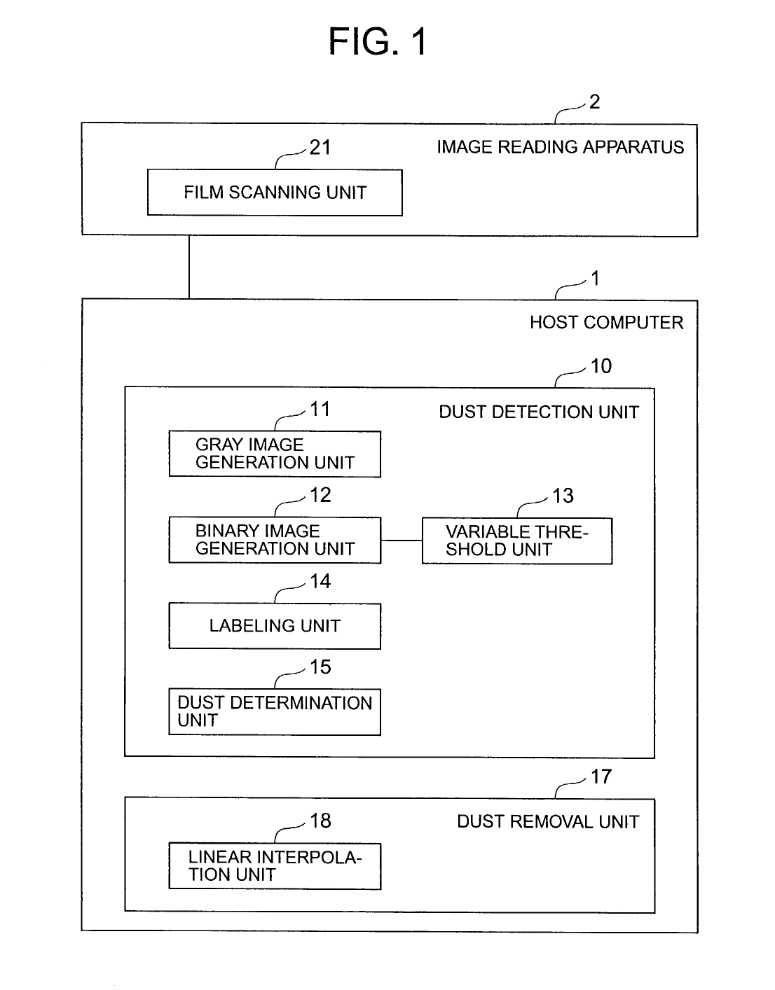

Referring to FIGS. 1 through 9, typical embodiments of the present invention will be described below.

FIG. 1 schematically shows a general configuration of an image reading system to which a typical embodiment of the present invention is applied. The image reading system includes an image reading apparatus 2 and a host computer 1. The image reading apparatus 2 has a film scanning (or reading) unit 21 and provides read image data to the host computer 1 connected with it. The host computer 1 includes a dust detection unit 10 and dust removal unit 17.

The dust detection unit 10 processes read image data provided from the image reading apparatus 2 and detects image components of the dust contained in the read image data. The dust detection unit 10 has a gray image generation unit 11 for converting color image data provided from the image reading apparatus 2 into a monochrome, gray image. The dust detection unit 10 includes a binary-image generation unit 12 for converting the gray image, which is a multi-valued image, into a binary image and a variable threshold unit 13 for changing a threshold applied in generating the binary image. The dust detection unit 10 includes a labeling unit 14 for slicing discrete image blocks from the binary image and a dust determination unit 15 for determining a dust read image in the sliced discrete image blocks.

The dust removal unit 17 includes a linear interpolation unit 18 for interpolating pixels involved in a removed dust read image.

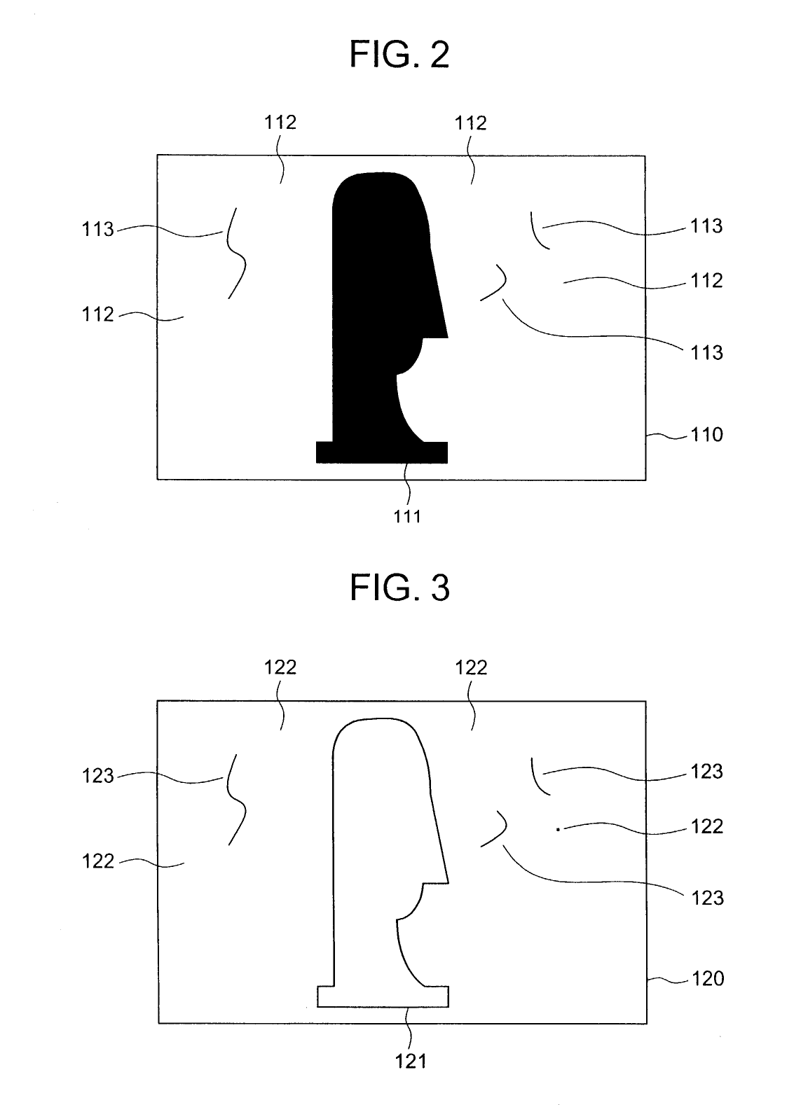

Referring to FIGS. 2 through 6, a control process performed by the image reading system for removing dust will be described.

FIG. 2 shows an image 110 generated by using multi-valued image data (color image) provided to the host computer 1 from the image reading apparatus 2 or using gray image data generated from the color image by the gray image generation unit 11. As shown in FIG. 2, images 112 resulting from read spot dust and images 113 resulting from read lint-like dust are scattered around the silhouette, center image 111.

FIG. 3 shows a binary image 120 generated from the multi-valued image data by the binary image generation unit 12. The binary image 120 is generated through a high-precision binarization process using a threshold that varies according to the level of image data. Accordingly, the spot dust images 112 and lint-like dust images 113 scattered over the original image 110 don't vanish, but remain as heightened images 122 and 123 in the binary image 120. The silhouette, center image 111 is transformed into a hollow image 121 with its outline being enhanced.

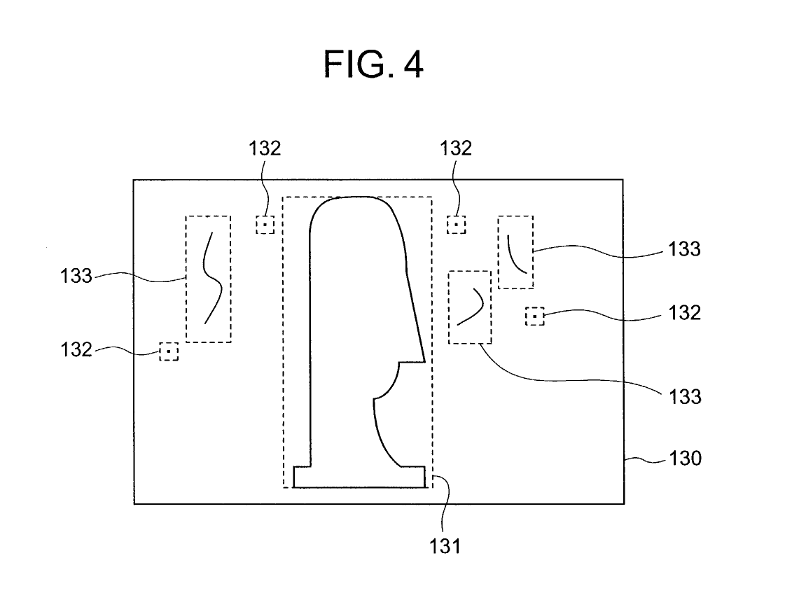

FIG. 4 shows an image 130 resulting from labeling of the binary image 120 by the labeling unit 14, in which image blocks are enclosed in boxes. The individual image blocks in boxes are examined to determine whether they are dust images.

That is, the dust determination unit 15 determines whether the size of a box is smaller than a predetermined reference value and whether the area of the percentage of image data to the area of the box is less than a predetermined reference value. If so, the dust determination unit determines that the image in the box is a dust image resulting from read dust and that black pixels in the dust image are dust pixels resulting from the dust.

Based on the above described criterion, images in boxes 132 and 133 other than a box 131 positioned at a center of the image 130 shown in FIG. 4 are determined as dust images. Thus, the positions of individual dust pixels 132 and 133 contained in the read image can be identified.

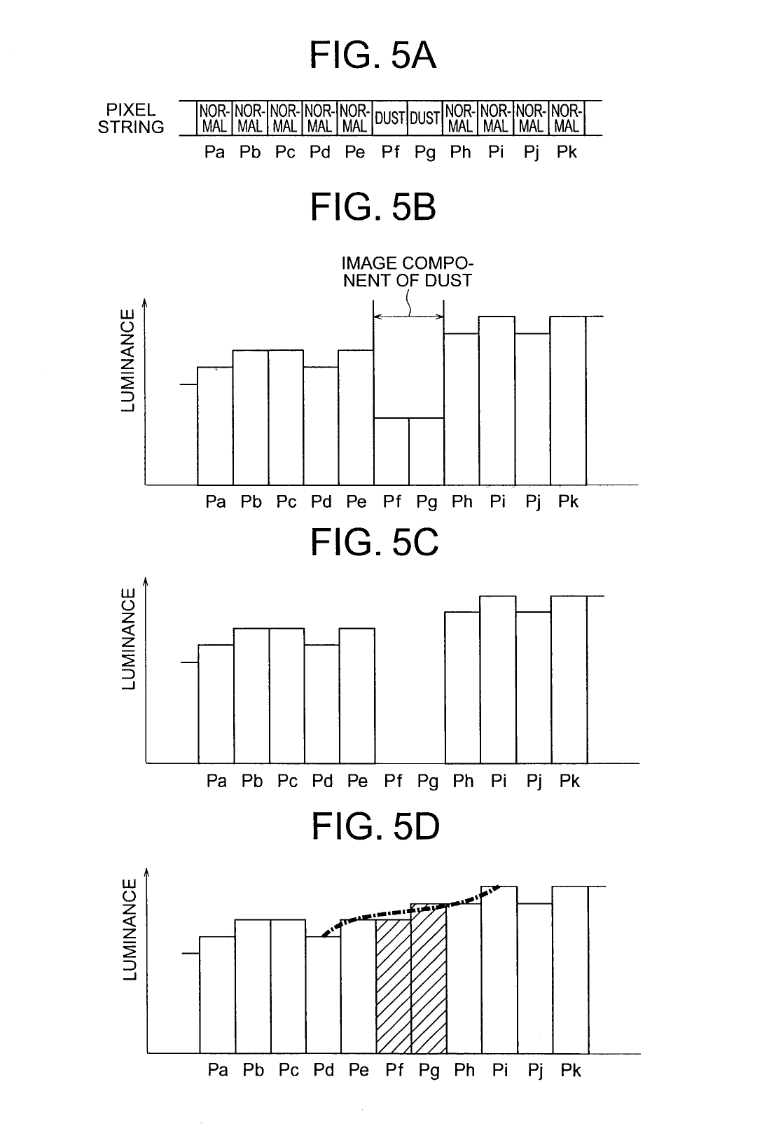

Referring to FIG. 5, the principle of dust pixel removal and correction performed by the dust removal unit 17 of the image reading system will be described below.

FIG. 5A shows an example of data representing the position of dust pixels. There appears in a string of pixels Pa through Pk information indicating that pixels Pf and Pg are dust pixels resulting from read dust. This results from the determination process shown in FIG. 4.

FIG. 5B shows luminance distribution of pixels Pa through Pk of the pixel string in image data transferred from the image reading apparatus. That is, comparing against the data shown in FIG. 5A, it is apparent that pixels Pf and Pg are dust component pixels.

FIG. 5C shows the image data from which dust component pixels Pf and Pg are removed.

FIG. 5D shows image data in which the original luminance values of dust component pixels Pf and Pg deleted from the image data shown in FIG. 5C are interpolated by the liner interpolation unit 18. As one example of a method of interpolating pixel data, linear interpolation, for example, may be used to determine interpolation values, in which luminance values of neighboring pixels are multiplied by a weighting factor to calculate the mean value.

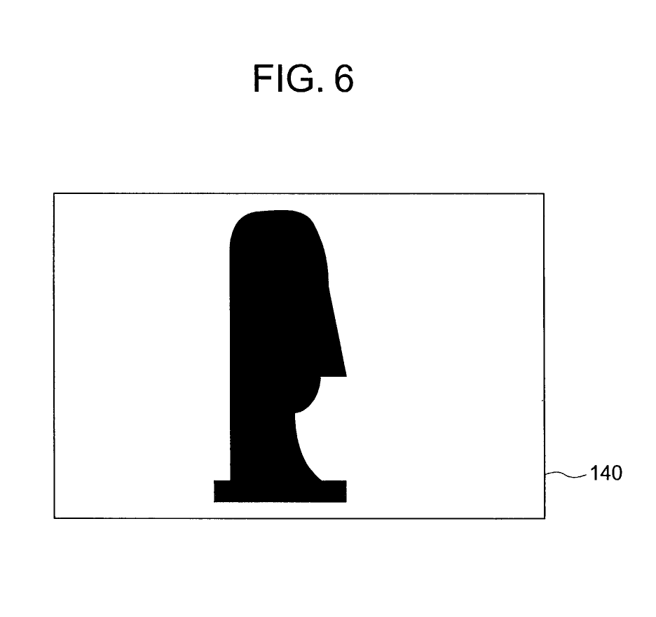

FIG. 6 shows a read image 140 resulting from the interpolation by the liner interpolation unit 18. In this image 140, only the dust pixels are removed and appropriate values are interpolated. As a result, a clear image quality can be retained in the remaining original image area.

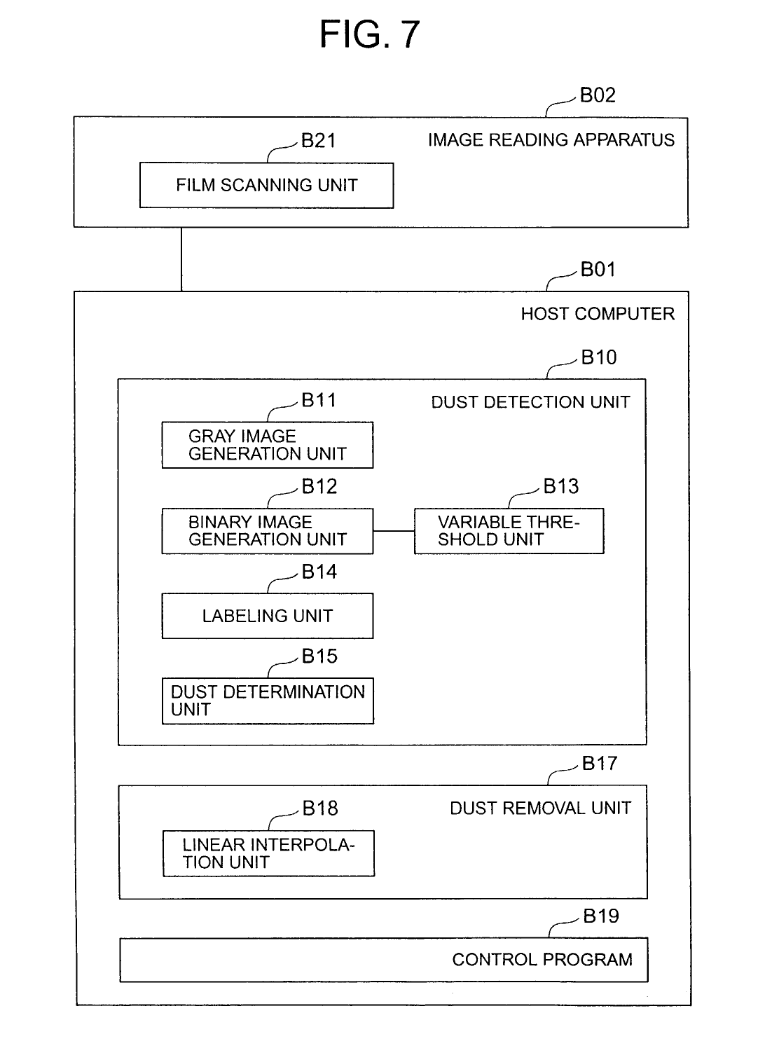

Referring to FIGS. 7, 8 and 9, a control process performed by an image reading system for correcting dust pixel portions contained in image data read from photographic film according to a typical embodiment of the present invention will be described below.

Referring to a block diagram shown in FIG. 7, the image reading system includes an image reading apparatus B02 and a host computer B01. The image reading apparatus B02 has a film scanning unit B21.

The host computer B01, which is connected to the image reading apparatus B02 and receives read image data, includes a dust detection unit B10 for detecting dust pixel in the read image received from the image reading apparatus B02, a dust removal unit B17 for correcting pixels involved in a dust read component of the image data based on information relating to the dust pixel, and a control program unit B19 for storing a control program for defining a process for controlling the image reading system.

The dust detection unit B10 includes a gray image generation unit B11 for generating monochrome multi-valued image data, a binary image generation unit B12 for generating binary image data from the monochrome multi-valued image data, a variable threshold unit B13 for providing threshold data to the binary image generation unit B12, a labeling unit B14 for specifying and slicing an image block from the binary image data, and a dust determination unit B15 for identifying an image block containing a read dust image among image blocks sliced by the labeling unit B14 and specifying its dust pixels.

The dust removal unit B17 includes a linear interpolation unit B18 for correcting dust pixels, identified by the dust determination unit B15, in the read image data provided from the image reading apparatus B02.

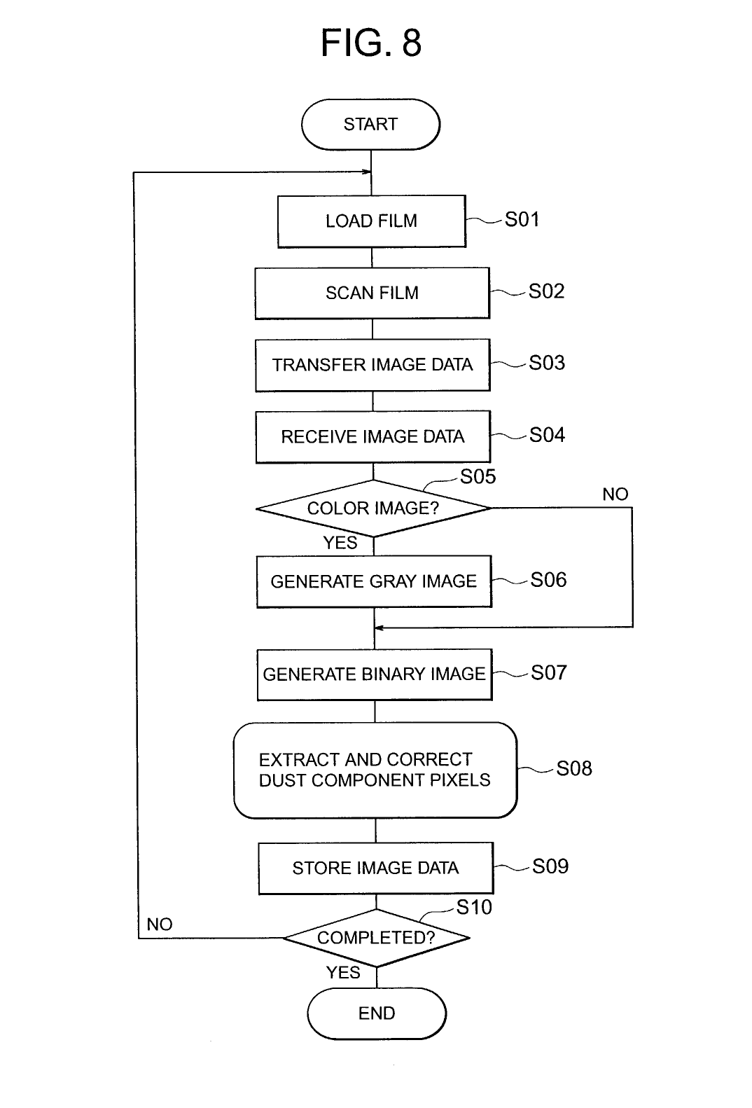

A control process performed by the image reading system will be described below on the basis of a flowchart shown in FIG. 8. Reference numerals used in the description of the steps of the control process correspond to those shown in FIG. 7.

At step S01, an operator loads the film scanning unit B21 of the image reading apparatus B02 with photographic film from which an image is to be read and activates a read operation.

At step S02, the film scanning unit B21 scans the photographic film and generates read image data.

At step S03, the image reading apparatus B02 transfers the read image data to the host computer B01.

The host computer B01 receives the read image data transferred from the image reading apparatus B02 at step S04. If it is determined that the read image data is color image data at step S05, the process proceeds to step S06, where the gray image generation unit B11 generates monochrome, gray image data based on the color image data. The read image data transferred at step S04 and the gray image data generated at step S06 are as described earlier on the basis of FIG. 2.

At step S07, the binary image generation unit B12 applies a variable threshold provided from the variable threshold unit B13 based on the gray image data (multi-valued image data) to generate binary image data. An example of the binary image data generated at step S07 is as described above with respect to FIG. 3.

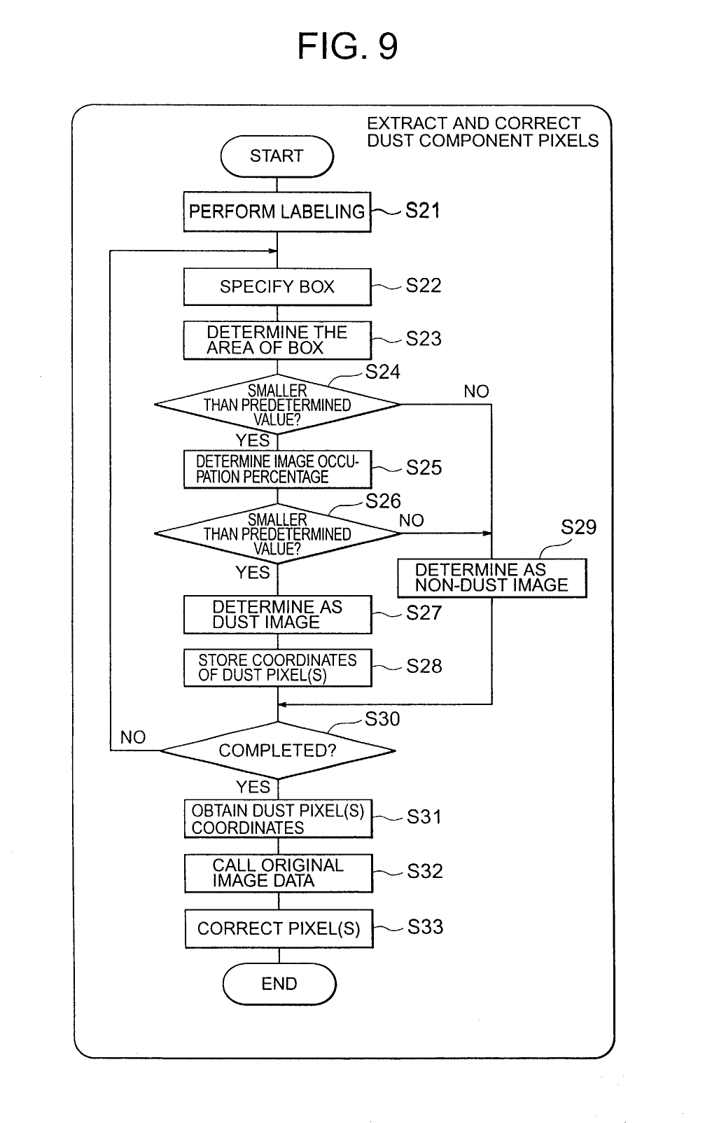

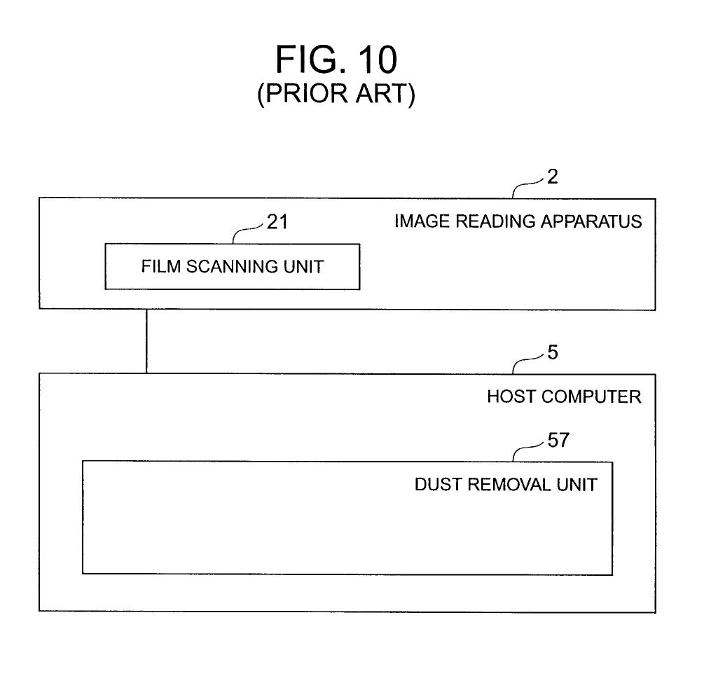

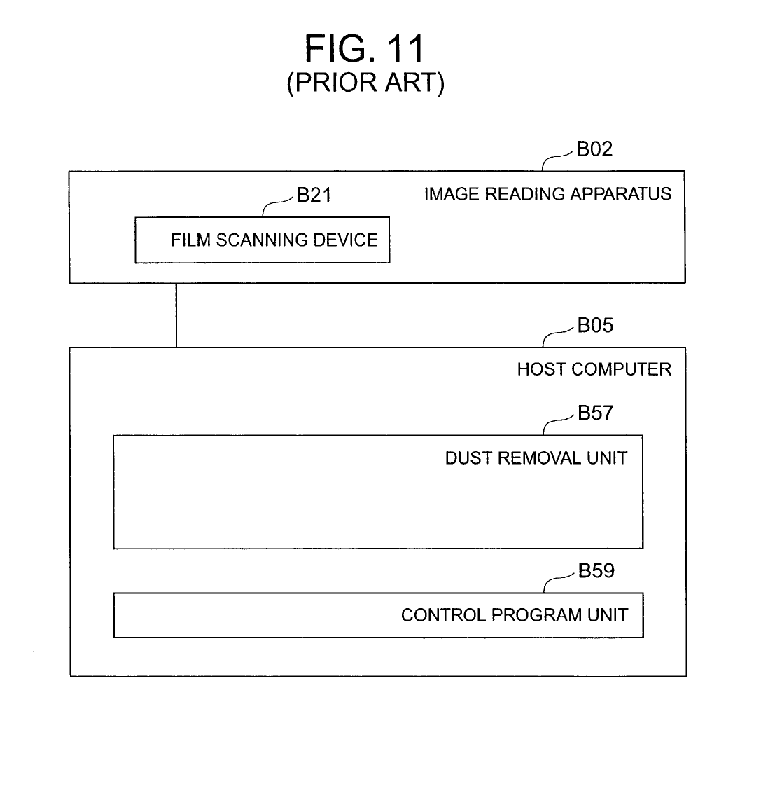

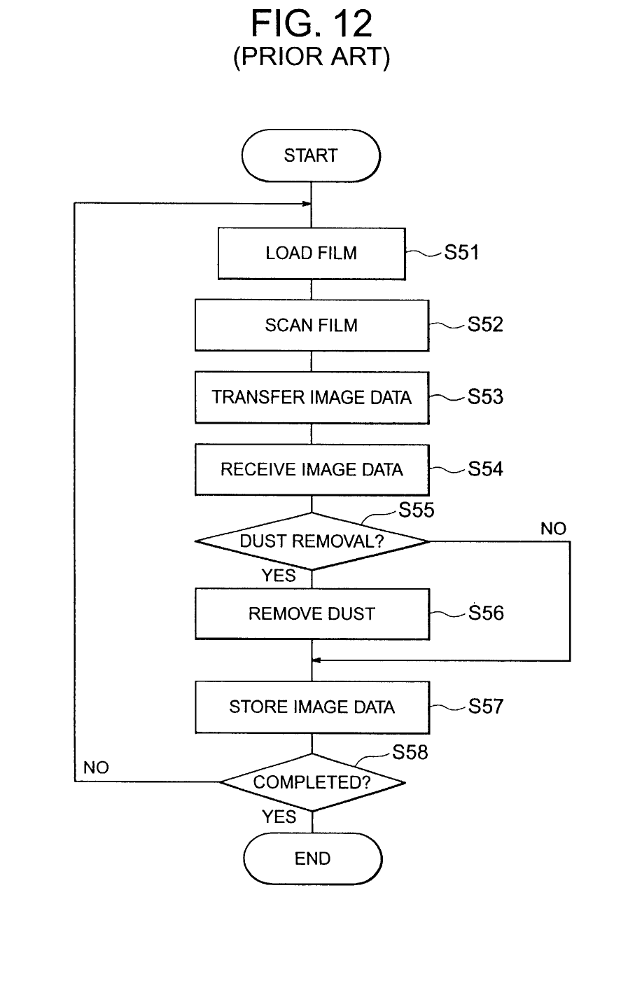

At step S08, the host computer B01 extracts and corrects dust component pixels. Details of the control process performed at step S08 is shown in FIG. 9.

With reference to FIG. 9, the control process performed at step S08 is now described below in detail.

At step S21, the labeling unit B14 encloses individual image blocks in the binary image data with boxes. An example of image blocks enclosed with boxes at step S21 is as described with respect to FIG. 4. At step S22, the dust determination unit B15 specifies a box to be examined.

The dust determination unit B15 determines the area of the specified box at step S23 and, if determines at step S24 that the area of the specified box is smaller than a predetermined area, proceeds to step S25.

At step S25, the dust determination unit B15 obtains the image occupation percentage, which is the percentage of the area occupied by image data to the area of specified box. Then, if the dust determination unit B15 determines at step S26 that the image occupation percentage is smaller than a predetermined value, it proceeds to step S27, where it determines that the image portion enclosed in the box is a dust image portion resulting from read the dust.

At step S28, the dust determination unit B15 stores the coordinates of all the pixels included in the dust image.

On the other hand, if it is determined at step S24 that the area of the box is not smaller than the predetermined value, or if it is determined at step S26 that the percentage of the area occupied by the image data to the area of the box is not smaller than the predetermined value, then the process proceeds to step S29, where it is determined that the image block is not a dust image resulting from read dust (that is, it is determined as a non-dust image). Then, the process further proceeds to step S30.

At step S30, if there is no further box to be examined, the process for extracting dust components pixels ends. On the other hand, if there is another box to be examined at step S30, the process returns to step S22.

At step S31, the dust removal unit B17 obtains the coordinates of the dust pixels stored at step S28. Then, at step S32, it calls the original image data stored beforehand and, at step S33, corrects the dust pixels.

Of course, if the original image data is a color image data consisting of R, G, and B component data, the correction is applied to each of the R, G, and B component data.

The detailed process from step S31 through step S33 for image data correction is based on the embodiment shown in FIG. 5 and the image data resulting from the correction is as shown in the example in FIG. 6.

Returning to FIG. 8, the description of the control process will be continued below. At step S09, the image data corrected by removing the dust pixels is stored in a predetermined file.

If there is further photographic film from which images are to be read at step S10, the process returns to step S01, where the operator loads the film scanning unit with the photographic film. On the other hand, if there is no further photographic film from which images are to be read at step S10, the photographic film image read process ends.

The present invention provides the following advantages.

In a method of controlling an image reading system that includes an image reading apparatus having a mechanism for scanning photographic film and a host computer receiving image data from the image reading apparatus, individual image components of the dust resulting from dust on the photographic film which is read by the image reading apparatus are detected and only the read image components of the dust are removed to correct the image data.

This technique has the advantage that only the image components of the dust are removed without degrading any image quality of the image data provided by the image reading apparatus.

The host computer in the method of controlling the image reading system applies high-precision binarization to multi-valued image data provided from the image reading apparatus to determine a threshold according to individual pixel data and generates a binary image. It then applies labeling to the binary image to enclose each of black block images with a box. It identifies a black block image component that has a value less than a predetermined reference value as an image component of a dust.

This technique has the advantage that the host computer can identify, on a pixel basis, image components of the dust in the read image data provided from the image reading apparatus.

The host computer in the method of controlling image reading apparatus applies image correction to each of pixel identified as an image component of a dust to remove the image component of the dust.

This technique has the advantage that because the image reading system corrects only pixels of the image component of the dust in the read image data, pixels other than the image component of the dust pixels are not subjected to the correction process and, as a result, the image is not degraded and good image data free of dust components is generated.

The image reading system control program for defining a control process for an image reading system that includes an image reading apparatus having a mechanism for scanning photographic film and a host computer receiving image data from the image reading apparatus defines the steps of detecting each of image component of dust resulting from dust on the photographic film read by the image reading apparatus, and removing the image components of the dust resulting from the dust to correct the image data.

This technique has the advantage that the image reading system provides the control steps of identifying each of image component of dust and applying correction only to the image component of the dust.

What is claimed is:

1. A method of controlling an image reading system including an image reading apparatus having a mechanism to scan photographic film and a host computer receiving image data from the image reading apparatus, the method comprising:
detecting each of image component of dust resulting from dust stuck to the photographic film which is read by the image reading apparatus; and
removing only the image component of the dust resulting from the read dust to correct the image data.

2. A method of controlling an image reading system according to claim 1,
wherein the host computer applies binarization to multi-valued image data provided from the image reading apparatus to generate a binary image, the binarization determining a threshold according to each of pixel data; and
wherein the host computer applies labeling to the binary image to enclose each of black block images with a box, and specifies an image component of a black block image which has a value less than a predetermined reference value as an image component of a dust.

3. A method of controlling an image reading system according to claim 2, wherein the predetermined reference value is area of a box and percentage of an area occupied by image data to an area of a box.

4. A method of controlling an image reading system according to claim 3, wherein the host computer determines an area of each of the box, obtains the percentage of each of the box which has an area smaller than the predetermined reference value, to specify the image component of the black block image which has the percentage smaller than the predetermined reference value.

5. A method of controlling an image reading system according to claim 1, wherein the host computer applies image correction to each pixel which is specified as the image component of the dust to remove the image component of the dust.

6. A method of controlling an image reading system according to claim 5, wherein the host computer removes the pixel of the image component of the dust, and determines interpolation values by liner interpolation in which luminance values of neighboring pixels are multiplied by a weighting factor to calculate the mean value, to apply image correction.

7. An image reading system comprising:
an image reading apparatus having a mechanism to scan photographic film; and
a host computer receiving image data from the image reading apparatus,
wherein the host computer further comprises:
detecting means for detecting each of image component of dust resulting from dust stuck to the photographic film which is read by the image reading apparatus; and
removing means for removing only the image component of the dust resulting from the read dust to correct the image data.

8. An image reading system control program to control an image reading system including an image reading apparatus having a mechanism to scan photographic film and a host computer receiving image data from the image reading apparatus, wherein the program causes the computer to perform:
detecting each of image component of dust resulting from dust stuck to the photographic film which is read by the image reading apparatus; and
removing only the image component of the dust resulting from the read dust to correct the image data.

9. A computer readable medium recording an image reading system control program to control image reading system including an image reading apparatus having a mechanism to scan photographic film and a host computer receiving image data from the image reading apparatus, wherein the program causes the computer to perform:
detecting each of image component of dust resulting from dust stuck to the photographic film which is read by the image reading apparatus; and
removing only the image component of the dust resulting from the read dust to correct the image data.
